(19) United States
(12) Patent Application Publication
(10) Pub. No.: US 2023/0286549 A1
(43) Pub. Date: Sep. 14, 2023

(54) METHOD FOR TRANSITIONING CONTROL OF A VEHICLE FROM AN AUTONOMOUS DRIVING SYSTEM TO A HUMAN DRIVER, DATA PROCESSING APPARATUS, SYSTEM, COMPUTER PROGRAM AND COMPUTER-READABLE STORAGE MEDIUM

(71) Applicant: Volvo Car Corporation, Göteborg (SE)

(72) Inventor: Casper WICKMAN, Göteborg (SE)

(21) Appl. No.: 18/119,455

(22) Filed: Mar. 9, 2023

(30) Foreign Application Priority Data
Mar. 14, 2022 (EP) 22161926.5

(51) Int. Cl. B60W 60/00; B60W 50/14

(52) U.S. Cl. CPC B60W 60/0053; B60W 50/14; B60W 60/00186; B60W 2050/007

(57) ABSTRACT

A method for transitioning control of a vehicle from an autonomous driving system to a human driver. The method includes receiving, from the autonomous driving system, a take-over request. Additionally, the method includes determining whether a singular switching means is actuated, and triggering a deactivation of the autonomous driving system under the only condition that the singular switching means is determined to be actuated. Moreover, a data processing apparatus is provided. The data processing apparatus includes means for carrying out the method. Furthermore, a system for transitioning control of a vehicle from an autonomous driving system to a human driver is provided. The system includes a steering wheel, the data processing apparatus and the singular switching means. Additionally, a corresponding computer program and a corresponding non-transitory computer-readable storage medium provided.

### CROSS-REFERENCE TO RELATED APPLICATION

The present disclosure claims the benefit of priority of co-pending European Patent Application No. 22 161 926.5, filed on Mar. 14, 2022, and entitled “METHOD FOR TRANSITIONING CONTROL OF A VEHICLE FROM AN AUTONOMOUS DRIVING SYSTEM TO A HUMAN DRIVER, DATA PROCESSING APPARATUS, SYSTEM, COMPUTER PROGRAM AND COMPUTER-READABLE STORAGE MEDIUM,” the contents of which are incorporated in full by reference herein.

### TECHNICAL FIELD

The present disclosure relates to a method for transitioning control of a vehicle from an autonomous driving system to a human driver. Additionally, the present disclosure is directed to a data processing apparatus including means for carrying out the above method. Moreover, the present disclosure relates to a system for transitioning control of a vehicle from an autonomous driving system to a human driver. Furthermore, the present disclosure is directed to a corresponding computer program and a corresponding computer-readable storage medium.

### BACKGROUND

Vehicles providing autonomous driving functionalities are known. In such vehicles, tasks such as longitudinal guiding and lateral guiding of the vehicle may be performed by an autonomous driving system, i.e. without the interaction of a human driver. In other words, the autonomous driving system is responsible for steering the vehicle, accelerating and braking.

Some vehicles having autonomous driving functionalities require that upon request of the autonomous driving system, the human driver rapidly takes over the control of the vehicle. This may be the case for vehicles offering autonomous driving functionalities according to Level 3 as defined by the Society of Automotive Engineers (SAE). In an illustrative example, the vehicle approaches a construction area and the autonomous driving system detects that it will not be able to further guide the vehicle, e.g. due to the absence of road markings. Consequently, the human driver is requested to take over control of the vehicle.

It is obvious that for the safety of all traffic participants, the transitioning of the control from the autonomous driving system to the human driver needs to happen in a smooth and calm manner.

### SUMMARY

It is an objective of the present disclosure to further improve known methods and systems for transitioning control of a vehicle from an autonomous driving system to a human driver.

According to a first aspect, there is provided a method for transitioning control of a vehicle from an autonomous driving system to a human driver, including: receiving, from the autonomous driving system, a take-over request, determining whether a singular switching means is actuated, and triggering a deactivation of the autonomous driving system under the only condition that the singular switching means is determined to be actuated.

In this context, a take-over request is to be understood as a message or a signal delivered by the autonomous driving system. The message or signal carries the information that the human driver needs to take over the control of the vehicle.

In the present disclosure, the autonomous driving system is a system which is configured to perform the longitudinal guiding and the lateral guiding of the vehicle. In other words, the autonomous driving system is configured to steer the vehicle, accelerate the vehicle and decelerate the vehicle without the interaction of a human driver. Another term of lateral guiding is transversal guiding.

A singular switching means is to be understood as exactly one switching means. This switching means may be switched between two states, i.e. a first state and a second state, wherein one of the first state and the second state is an actuated state and the respective other state is a non-actuated state. These states are distinct from one another. These states do neither overlap nor is it possible to smoothly or gradually transition from one state into the respective other state. The switching means is configured for being intentionally actuated by the human driver. Thus, the switching means is different from any kind of a sensor or detector which generally operates independently from an intention of the human driver. Especially, a hands-on-detector is to be seen as a sensor and not as a switching means in the sense of the present disclosure.

Triggering a deactivation of the autonomous driving system may be rephrased in that an autonomous driving mode is terminated and a manual or human driving mode is started.

Thus, actuating the singular switching means may be seen as a confirmation of taking over the control of the vehicle by the human driver.

The fact that a singular switching means has to be actuated as the only condition for triggering the deactivation of the autonomous driving system has the advantage that the actuation of the switching means can be performed by a single hand of the human driver. In nearly all autonomous driving situations, it is easier for the human driver to confirm the take-over of control and to at least initially perform the control with a single hand instead of two hands. This becomes clear if one imagines that in a situation in which the autonomous driving system controls the vehicle, the human driver may do other things, e.g. eat, drink, read, play a game, watch a video, work. Thus, the human driver may have things other than the steering wheel in one hand or both hands, e.g. a book, food, a drink, an electronic device. Thus, before being able to take over the control of the vehicle, the human driver will need to liberate at least one of his or her hands. These advantages are especially clear, if the human driver performs an activity needing both his or her hands while the autonomous driving system is controlling the vehicle. Thus, using the method according to the present disclosure, the human driver is able to take-over the control of the vehicle in a quick and simple manner performing a so-called “one hand take over” and “single hand take over”. Consequently, the take-over happens in a calm and serene manner. This keeps a stress level of the human driver low and, therefore, enhances driving safety for the human driver and other traffic participants. Due to the reduced stress level, it is possible that a one-hand take-over even increases driving safety as compared to a two-hand take-over procedure.

According to an example, the deactivation of the autonomous driving system may be triggered if the singular switching means is determined to be actuated within a defined time period. This defined time period starts when the take-over request is received. Thus, for taking over the control by the human driver, the singular switching means needs to be actuated within the defined time period. The defined time period may also be designated as a time window. The defined time period may be 5 to 15 seconds, especially 8 to 12 seconds. In an example, the defined time period is 10 seconds. Thus, the human driver needs to take over the control relatively quickly. This ensures that the human driver takes over control of the vehicle before the autonomous driving system enters a situation in which it is not able to control the vehicle any more. Consequently, driving safety is enhanced.

According to an example, the method may include triggering a low risk manoeuver if the singular switching means is not determined to be actuated within the defined time period. A low risk manoeuver may also be designated as a minimum risk manoeuver. This means that an autonomous procedure for stopping the vehicle is triggered. In other words, the vehicle will be brought into a safe state if the human driver is not able to take over control within the defined time period or time window.

In an example, the deactivation of the autonomous driving system may be triggered if the singular switching means is determined to be actuated for a defined time. The defined time may be 0.5 to 2 seconds, especially 0.8 to 1.2 seconds. In an example, the time period is 1 second. Using such a defined time has the effect that the autonomous control of the vehicle is only triggered to be terminated in a case in which the human driver intentionally actuates the singular switching means. In a case in which the human driver unintentionally actuates the singular switching means for a time being shorter than the defined time, the autonomous driving system continues to control the vehicle.

According to an example, the method may further include triggering a notification for the human driver. Thus, the human driver is informed that he or she is requested to take over the control of the vehicle. The notification may be at least one of audible, visual, and tactile. Thus, the human driver is in a position to quickly react to the take-over request.

In an example, the method may further include requesting a steering wheel to move into an actuation position. Alternatively or additionally, a driver seat is requested to move into an upright position. This applies if the steering wheel is in a retracted or stowed position while the vehicle is controlled by the autonomous driving system. Consequently, while the vehicle is controlled by the autonomous driving system, the human driver has more space to perform activities other than steering the vehicle. In an actuation position, the steering wheel is in a position in which it can be comfortably grabbed by the human driver. Usually, the steering wheel is closer to the human driver when in the actuation position than when in the retracted or stowed position. As far as the driver seat is concerned, its back rest may be in a comfort position while the vehicle is controlled by the autonomous driving system. The driver may thus assume a relaxed seating positing. By requesting the steering wheel to move into the actuation position and/or by requesting the driver seat to move into an upright position, grabbing the steering wheel and taking over control is facilitated.

It is noted that in the present disclosure, the term steering wheel is to be understood to include any means that is configured for steering the vehicle. It is not necessary that this means is shaped as a wheel. Thus, the term steering wheel also designates a steering yoke or so-called rectangular steering wheels.

The method according to the present disclosure may be at least partly computer-implemented, and may be implemented in software or in hardware, or in software and hardware. Further, the method may be carried out by computer program instructions running on means that provide data processing functions. The data processing means may be a suitable computing means, such as an electronic control module etc., which may also be a distributed computer system. The data processing means or the computer, respectively, may include one or more of a processor, a memory, a data interface, or the like.

According to a second aspect, there is provided a data processing apparatus, including means for carrying out the method according to the present disclosure. Consequently, the processing apparatus facilitates the transitioning of the control of a vehicle from an autonomous driving system to a human driver. The transitioning is especially simple for the human driver such that it can be performed in a quick manner. This enhances driving safety for the human driver and other traffic participants.

It is noted that the data processing apparatus is explained as an entity being separate from the autonomous driving system. This is done for the ease of explanation. Of course, the data processing apparatus may as well be formed as a part of an autonomous driving system. In such a case the data processing apparatus forms a first sub-unit of the autonomous driving system, wherein the functionalities of the autonomous driving system as has been explained above (steering, accelerating, decelerating) are performed by a second sub-unit of the autonomous driving system. Consequently, the interactions between the data processing apparatus and the autonomous driving system as described above, are realized as interactions of the first sub-unit of the autonomous driving system and the second sub-unit of the autonomous driving system.

According to a third aspect, there is provided a system for transitioning control of a vehicle from an autonomous driving system to a human driver. The system includes a steering wheel, a data processing apparatus according to the second aspect of the present disclosure, and a first singular switching means. The first singular switching means is located in a defined position on the steering wheel such that the first singular switching means can be actuated by a single human hand. Moreover, the first singular switching means is communicatively coupled to the data processing apparatus such that the data processing apparatus can determine whether the first singular switching means is actuated. Thus, a human driver can take over the control of the vehicle from the autonomous driving system using a single hand. This is easy for the human driver in nearly all autonomous driving situations, since in a situation, in which the autonomous driving system controls the vehicle, the human driver may be occupied doing other things than waiting for a request to steer the vehicle, e.g. eat, drink, read, play a game, watch a video, work. Thus, using the method according to the present disclosure, the human driver is able to take-over the control of the vehicle in a quick and simple manner performing a so-called “one hand take over” and “single hand take over”. Consequently, the take-over happens in a calm and serene manner. This keeps a stress level of the human driver low and, therefore, enhances driving safety for the human driver and other traffic participants. Moreover, due to the one hand take over, also other hazardous events like unintentionally dropping objects or spilling hot drinks inside the vehicle are mitigated.

In an example, the system may further include a second singular switching means being located in a defined position on the steering wheel such that the second singular switching means can be actuated by a single human hand, wherein the second singular switching means is communicatively coupled to the data processing apparatus such that the data processing apparatus can determine whether the second singular switching means is actuated. In this configuration, the human driver can confirm the take-over of control over the vehicle by actuating either the first singular switching means or the second singular switching means. Consequently, for the human driver, taking over control is further facilitated since the human driver can use the singular switching means that is better reachable. This may depend on the fact whether the human drive holds an object, e.g. a book, food, a drink, an electronic device, in his or her left hand, in his or her right hand or in both hands. If the human driver has one free hand, it may be convenient to use the free hand to confirm the take-over of control and at least initially perform the control of the vehicle with this hand. In a case in which the human driver holds objects in both hands, one of these object may be easier to put away than the other. Thus, the human driver can put away the object that is easier to put away and take over control while the object that is less easy to put away at least temporarily remains in one of the human driver's hands. Thus, also in these cases, taking over control is facilitated. This leads to enhanced driving safety.

In an example, the first singular switching means and the second singular switching means may be redundant with respect to each other. This means that the first singular switching means and the second singular switching means have the exact same functionality and, thus, it does not matter whether the human driver takes over control using the first singular switching means or the second singular switching means. The human driver can, thus, use the switching means that appears most convenient in a situation in which take-over is requested.

In an example, in a standard position of the steering wheel, the first singular switching means may be arranged in a left half of the steering wheel and the second singular switching means may be arranged in a right half of the steering wheel or vice versa. In this context, the standard position of the steering wheel is defined as the position of the steering wheel which corresponds to the wheels of the vehicle being oriented straight ahead such that the vehicle would drive straight ahead. In such a configuration, one of the singular switching means is easily reachable by a left hand of the human driver and the other one is easily reachable by a right hand of the human driver. This also applies if the steering wheel has been turned out of its standard position. Thus, the human driver can actuate at least one of the first singular switching means and the second singular switching means with great ease within a comparatively short time.

In an example, at least one of the first singular switching means and the second singular switching means may be a press switch or a paddle switch. Such switching means may be actuated by the human drive in a simple manner. Furthermore, they offer a reliable switching functionality. Additionally, such switching means are little prone to being actuated unintentionally. Altogether, such switching means may be reliably actuated.

In an example, at least one of the first singular switching means and the second singular switching means may include at least one of a redundant power supply, a redundant signal connection, and two redundant signal generation units. Thus, at least one of the first singular switching means and the second singular switching means is highly reliable. In an example, both the first singular switching means and the second singular switching means include at least one of a redundant power supply, a redundant signal connection, and two redundant signal generation units. Thus, both singular switching means are highly reliable.

In an example, both the first singular switching means and the second singular switching means fulfil the Level D requirements of the Automotive Safety Integrity Level (ASIL) risk classification scheme as defined by the ISO 26262 standard.

According to a fourth aspect, there is provided a computer program including instructions which, when the program is executed by a computer, cause the computer to carry out the method according to the present disclosure. The computer may be formed by the data processing apparatus as described above.

According to a fifth aspect, there is provided a computer-readable storage medium including instructions which, when executed by a computer, cause the computer to carry out the method according to the present disclosure. Again, the computer may be formed by the data processing apparatus as described above.

It should be noted that the above examples may be combined with each other irrespective of the aspect involved. Accordingly, the method may be combined with structural features and, likewise, the apparatus and the system may be combined with features described above with regard to the method and so on.

These and other aspects of the present disclosure will become apparent from and elucidated with reference to the examples described hereinafter.

### BRIEF DESCRIPTION OF THE DRAWINGS

Examples of the disclosure will be described in the following with reference to the following drawings.

FIG. 1 shows a system according to the present disclosure for transitioning control of a vehicle from an autonomous driving system to a human driver, including a data processing apparatus according to the present disclosure, a computer program according to the present disclosure, and a computer-readable storage medium according to the present disclosure, wherein the data processing apparatus is configured to perform a method according to the present disclosure,

FIG. 2 shows a steering wheel of the system of FIG. 1 in more detail,

FIG. 3 shows an alternative steering wheel that can be used instead of the steering wheel of FIG. 2,

FIG. 4 shows a further alternative steering wheel that can be used instead of the steering wheel of FIG. 2 or instead of the steering wheel of FIG. 3, and

FIG. 5 illustrates steps of the method according to the present disclosure.

The figures are merely schematic representations and serve only to illustrate examples of the disclosure. Identical or equivalent elements are in principle provided with the same reference signs.

### DETAILED DESCRIPTION

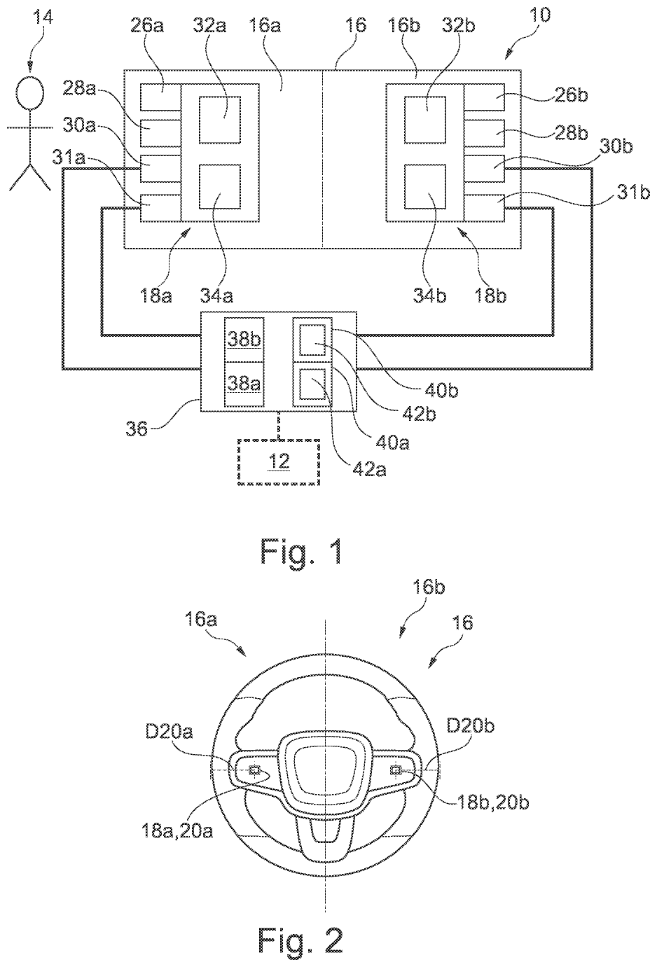

FIG. 1 shows a system 10 for transitioning control of a vehicle from an autonomous driving system 12 to a human driver 14. The system 10 includes a steering wheel 16. In a first defined position, a first singular switching means 18a is located on the steering wheel 16. The first singular switching means 18a is arranged on the steering wheel 16 such that it can be actuated by a single human hand (see especially FIGS. 2 to 4). Moreover, in a second defined position, a second singular switching means 18b is located on the steering wheel 16. Also the second singular switching means 18b is arranged on the steering wheel 16 such that it can be actuated by a single human hand (see also FIGS. 2 to 4).

As can be seen from FIG. 2, the first singular switching means 18a and the second singular switching means 18b may be press switches 20a, 20b being arranged on a front side of the steering wheel 16. The front side of the steering wheel 16 is the side of the steering wheel 16 which faces the human driver 14 when the steering wheel 16 is mounted in a vehicle.

Moreover, the press switches 20a, 20b are arranged such that they can be easily reached by a human hand holding the steering wheel rim, especially with a thumb of the human hand grabbing the steering wheel rim. In more details, a distance D20a, D20b between each of the press switches 20a, 20b and the respectively closest portion of the outer circumference of the steering wheel 16 is shorter than a length of a thumb of the human hand.

In the present example, the distances D20a, D20b are 4 to 5 centimeters respectively.

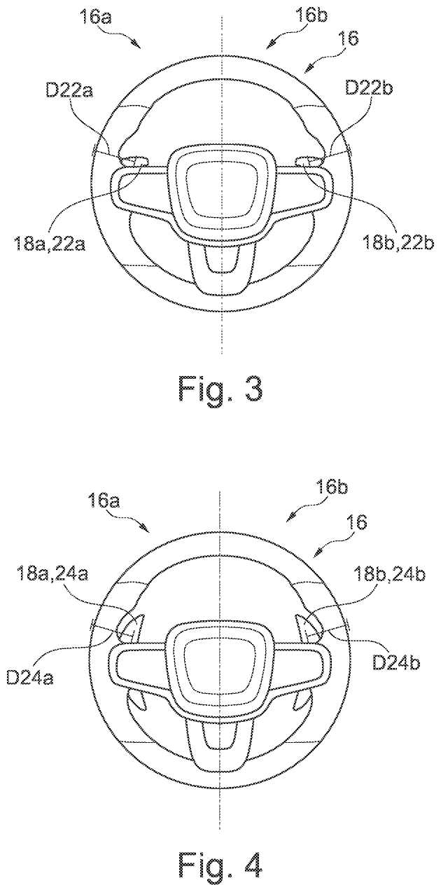

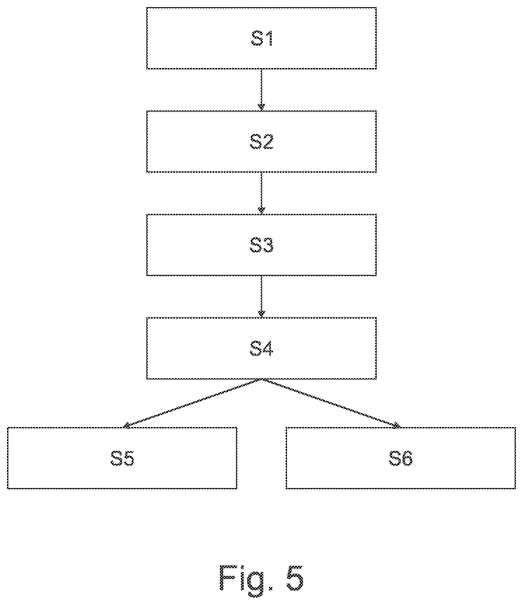

Alternatively, as can be seen from FIG. 3, the first singular switching means 18a and the second singular switching means 18b may be paddle switches 22a, 22b being actuatable via the front side of the steering wheel 16.

Also the paddle switches 22a, 22b are arranged such that they can be easily reached by a human hand holding the steering wheel rim, especially with a thumb of the human hand grabbing the steering wheel rim. In more details, a distance D22a, D22b between each of the paddle switches 22a, 22b and the respectively closest portion of the outer circumference of the steering wheel 16 is shorter than a length of a thumb of the human hand.

In the present example, the distances D22a, D22b are 3 to 5 centimeters respectively.

A further alternative can be seen in FIG. 4. In this alternative, the first singular switching means 18a and the second singular switching means 18b may be paddle switches 24a, 24b which are actuatable via the back side of the steering wheel 16.

Thus, the paddle switches 24a, 24b are arranged such that they can be easily reached by a human hand holding the steering wheel rim, especially with one or more of the index finger, the middle finger, the ring finger and the little finger which are laid around the steering wheel rim. A distance D24a, D24b between the paddle switches 24a, 24b and the respectively closest portion of the outer circumference of the steering wheel 16 is shorter than a length of at least one of the fingers mentioned above.

In the present example, the distances D24a, D24b are 3 to 5 centimeters respectively.

In FIGS. 2 to 4, the steering wheel 16 is shown in a so-called standard position, i.e. in a position that corresponds to a straight orientation of the wheels being coupled to the steering wheel 16. In this standard position, the first singular switching means 18a is arranged in a left half 16a of the steering wheel 16 and the second singular switching means 18b is arranged in a right half 16b of the steering wheel 16. This is the case for all alternatives shown in FIGS. 2 to 4.

It is noted that the straight orientation of the wheels being coupled to the steering wheel 16 is used for explaining the standard position of the steering wheel 16 only. Of course, the vehicle may be equipped with a steer by wire system, i.e. the steering wheel 16 may not be mechanically coupled to the wheels. In such a configuration, the orientation of the steering wheel 16 with respect to the wheels may be generally freely chosen. A steer by wire system has the advantage that the steering wheel 16 may stand still even though the autonomous driving system 12 steers the vehicle.

Furthermore, in all alternatives, the first singular switching means 18a includes a redundant power supply which is represented by a first power connector 26a and a second power connector 28a.

Additionally, the first singular switching means 18a includes a first signal connector 30a and a second signal connector 31a. Thus, the first singular switching means 18a has a redundant signal connection.

Moreover, the first singular switching means 18a has two signal generation units 32a, 34a which are redundant with respect to one another. The signal generation units 32a, 34a are configured for generating an electric signal upon actuation of the first singular switching means 18a.

The same applies to the second singular switching means 18b.

Thus, also the second singular switching means 18b includes a redundant power supply which is represented by a first power connector 26b and a second power connector 28b.

Additionally, the second singular switching means 18b includes a first signal connector 30b and a second signal connector 31b. Thus, the second singular switching means 18b has a redundant signal connection.

Moreover, the second singular switching means 18b has two signal generation units 32b, 34b which are redundant with respect to one another.

The first singular switching means 18a and the second singular switching means 18b are redundant with respect to each other. This means that both switching means 18a, 18b offer the same functionality. In a case in which one of the switching means 18a, 18b is not available, the full functionality is still provided by the other of the switching means 18a, 18b.

The system 10 also includes a data processing apparatus 36.

The data processing apparatus 36 is communicatively coupled to the first singular switching means 18a via the first signal connector 30a and the second signal connector 31a.

Moreover, the data processing apparatus 36 is communicatively coupled to the second singular switching means 18b via the first signal connector 30b and a second signal connector 31b.

Moreover, the data processing means 36 is configured to determine whether the first singular switching means 18a is actuated and is configured to determine whether the second singular switching means 18b is actuated.

To this end, the data processing apparatus 36 includes redundant means 38a, 38b for processing data and redundant non-transitory computer-readable storage media 40a, 40b. Redundant computer programs 42a, 42b are stored on the respective non-transitory computer-readable storage media 40a, 40b.

In this context, the means 38a together with storage medium 40a and computer program 42a may be connected to the first singular switching means 18a via first signal connector 30a and to the second singular switching means 18b via first signal connector 30b. Moreover, the means 38b together with storage medium 40b and computer program 42b may be connected to the first singular switching means 18a via second signal connector 31a and to the second singular switching means 18b via second signal connector 31b.

The data processing apparatus 36 is communicatively connected to the autonomous driving system 12.

The data processing apparatus 36 is configured for performing a method for transitioning control of a vehicle from the autonomous driving system 12 to the human driver 14. In more detail, each of the computer-readable storage media 40a, 40b and the computer programs 42a, 42b being stored thereon includes instructions which, when being executed by the respective means 38a, 38b for processing data, cause the means 38a, 38b to carry out the method.

Each of the means 38a, 38b for processing data may be designated as a computer.

The method starts in a situation in which the autonomous driving system 12 controls the vehicle, i.e. the autonomous driving system 12 is responsible for steering, accelerating and decelerating the vehicle.

In such a situation, the autonomous driving system 12 may detect that it will not be able to further guide the vehicle, e.g. due to the absence of road markings.

In such a case, one of the data processing apparatuses 38a, 38b will receive, from the autonomous driving system 12, a take-over request as a first step S1. This means that a signal is transmitted to the respective data processing apparatus 38a, 38b including the information that the human driver 14 needs to take over control of the vehicle.

Subsequently, in a second step S2, a notification for the human driver 14 is triggered. Thus, the human driver 14 is informed that he or she needs to take over control. The notification for example includes displaying a graphic or text on a screen within the vehicle and issuing a warning sound.

It is noted that this does not at all influence the possibility that the driver can take over control on his or her own initiative, i.e. without being notified.

Also, in a third step S3, the steering wheel 16 will be requested to move to an actuation position, i.e. to approach the human driver 14 such that the human driver 14 can easily grab the steering wheel 16.

Additionally or alternatively, also a driver seat is requested to move into an upright position.

The third step S3 may be performed in parallel to the second step S2.

It is noted that the third step S3 is optional.

The human driver 14 will thus stop his or her current activity. If the human driver 14 holds one or more objects in his or her hands, he or she needs to liberate at least one hand.

The human driver 14 approaches one hand towards the steering wheel 16, more precisely towards the one out of the first singular switching means 18a and the second singular switching means 18b that is best reachable with the liberated hand.

At the same time, in a fourth step S4 of the method, it is determining whether one of the first singular switching means 18a and the second singular switching means 18b is actuated.

If the human driver 14 actuates one of the first singular switching means 18a and the second singular switching means 18b within a defined time period of for example 10 seconds, and the actuation is detected, in a fifth step S5 a deactivation of the autonomous driving system is triggered. More precisely, a deactivation of the autonomous driving system 12 is triggered.

In other words, an autonomous driving mode is terminated and a manual or human driving mode is started.

It is noted that the detection of the actuation of one of the first and second singular switching means 18a, 18b is the only condition for deactivating the autonomous driving system 12.

In the present example, the first singular switching means 18a or the second singular switching means 18b needs to be actuated for a defined time of for example 0.5 seconds.

In a case, in which no actuation of one of the first and second singular switching means 18a, 18b is detected within the defined time period of for example 10 seconds or in which the one of the first and second singular switching means 18a, 18b is actuated shorter than the defined time of for example 0.5 seconds, in a sixth step S6, a low risk manoeuver is triggered, i.e. the vehicle is autonomously stopped. This of course goes along with warnings of increasing intensity.

Other variations to the disclosed examples can be understood and effected by those skilled in the art in practicing the claimed disclosure, from the study of the drawings, the disclosure, and the appended claims. In the claims the word “comprising” does not exclude other elements or steps and the indefinite article “a” or “an” does not exclude a plurality. A single processor or other unit may fulfill the functions of several items or steps recited in the claims. The mere fact that certain measures are recited in mutually different dependent claims does not indicate that a combination of these measures cannot be used to advantage. A computer program may be stored/distributed on a suitable medium such as an optical storage medium or a solid-state medium supplied together with or as part of other hardware, but may also be distributed in other forms, such as via the Internet or other wired or wireless telecommunication systems. Any reference signs in the claims should not be construed as limiting the scope of the claims.

1. A method for transitioning control of a vehicle from an autonomous driving system to a human driver, the method comprising:
receiving, from the autonomous driving system, a take-over request;
determining whether a singular switching means is actuated; and
triggering a deactivation of the autonomous driving system under the only condition that the singular switching means is determined to be actuated.

2. The method of claim 1, wherein the deactivation of the autonomous driving system is triggered if the singular switching means is determined to be actuated within a defined time period.

3. The method of claim 2, further comprising triggering a low risk maneuver if the singular switching means is not determined to be actuated within the defined time period.

4. The method of claim 1, wherein the deactivation of the autonomous driving system is triggered if the singular switching means is determined to be actuated for a defined time.

5. The method of claim 1, further comprising triggering a notification for the human driver.

6. The method of claim 1, further comprising requesting a steering wheel to move into an actuation position and/or a driver seat to move into an upright position.

7. A system for transitioning control of a vehicle from an autonomous driving system to a human driver, the system comprising:
a steering wheel; and
a data processing apparatus comprising a memory storing instructions executed by a processor to:
receive, from the autonomous driving system, a take-over request;
determine whether a first singular switching means is actuated; and
trigger a deactivation of the autonomous driving system under the only condition that the singular switching means is determined to be actuated;
wherein the first singular switching means is located in a defined position on the steering wheel such that the first singular switching means can be actuated by a single human hand; and
wherein the first singular switching means is communicatively coupled to the data processing apparatus such that the data processing apparatus can determine whether the first singular switching means is actuated.

8. The system of claim 7, further comprising a second singular switching means located in a defined position on the steering wheel such that the second singular switching means can be actuated by a single human hand, wherein the second singular switching means is communicatively coupled to the data processing apparatus such that the data processing apparatus can determine whether the second singular switching means is actuated.

9. The system of claim 8, wherein the first singular switching means and the second singular switching means (18b) are redundant with respect to each other.

10. The system of claim 8, wherein, in a standard position of the steering wheel, the first singular switching means is arranged in a left half of the steering wheel and the second singular switching means is arranged in a right half of the steering wheel or vice versa.

11. The system of claim 8, wherein at least one of the first singular switching means and the second singular switching means is a press switch or a paddle switch.

12. The system of claim 8, wherein at least one of the first singular switching means and the second singular switching means comprises at least one of a redundant power supply, a redundant signal connection, and two redundant signal generation units.

13. A non-transitory computer readable medium comprising instructions stored in a memory and executed by a processor to carry out steps for transitioning control of a vehicle from an autonomous driving system to a human driver, the steps comprising:
receiving, from the autonomous driving system, a take-over request;
determining whether a singular switching means is actuated; and
triggering a deactivation of the autonomous driving system under the only condition that the singular switching means is determined to be actuated.

14. The non-transitory computer readable medium of claim 13, wherein the deactivation of the autonomous driving system is triggered if the singular switching means is determined to be actuated within a defined time period.

15. The non-transitory computer readable medium of claim 14, the steps further comprising triggering a low risk maneuver if the singular switching means is not determined to be actuated within the defined time period.

16. The non-transitory computer readable medium of claim 13, wherein the deactivation of the autonomous driving system is triggered if the singular switching means is determined to be actuated for a defined time.

17. The non-transitory computer readable medium of claim 13, the steps further comprising triggering a notification for the human driver.

18. The non-transitory computer readable medium of claim 13, the steps further comprising requesting a steering wheel to move into an actuation position and/or a driver seat to move into an upright position.
